(19) United States
(12) Patent Application Publication
(10) Pub. No.: US 2006/0178027 A1
(43) Pub. Date: Aug. 10, 2006

(54) Multi-functional power cord for medical handpiece

(75) Inventors: Pierre Terrade, Bordeaux (FR); Dominique Mariaulle, Saint-Aubin du Medoc (FR)

Correspondence Address: YOUNG & THOMPSON, 745 SOUTH 23RD STREET, 2ND FLOOR, ARLINGTON, VA, 22202, US

(73) Assignee: SOCIETE POUR LA CONCEPTION DES APPLICATIONS DES TECHNIQUES ELECTRONIQUES-SATELEC, MERIGNAC (FR)

(21) Appl. No.: 10/548,654

(22) PCT Filed: Mar. 12, 2004
(86) PCT No.: PCT/FR04/00606

§ 371 Date: Sep. 13, 2005

(30) Foreign Application Priority Data
Mar. 14, 2003 (FR) 03/03178

(51) Int. Cl. H01R 4/60

(52) U.S. Cl. 439/191

(57) ABSTRACT

A power cord (5) for a medical handpiece includes at least one longitudinal auxiliary housing (13) which is equipped with a radial slit (15) which communicates the auxiliary housing (13) with the exterior. The power card is equipped with a mechanism for positioning the flexible conduit inside the auxiliary housing, the mechanism including: elements (24) for positioning same on the cord (5), means for positioning the flexible conduit (17) at the inlet of the slit (15) of the cord (5), and applicator elements for pushing the conduit (17) into the auxiliary housing (13) through the slit (15) when the mechanism is moved along the length of the cord (5).

The present invention relates to a multifunction supply cord for a medical handpiece and more particularly to such cord provided with a mechanism permitting ensuring easily the use of this latter.

It is known that dental handpieces are supplied in energy and various fluids by a flexible cord which connects them to the block supporting the various instruments. Thus, this cord permits particularly carrying the electrical energy supply, and the supply of water and/or air to the handpiece. But it sometimes happens after certain operations, the handpiece is provided with a supply line for sterile liquid. To do this, use is made of a flexible external conduit which is connected at one of its ends to the handpiece and at its other end to the supply means for sterile fluid. Between these two, the sterile line follows substantially the supply cord of the handpiece on which it is fixed for example by means of clips that are provided from place to place along all its length.

A major drawback of such an arrangement is that, in the course of use, the various curvatures to which the supply cord is subjected have the effect, because of the presence of the clips which prevent the conduit from deforming like its support cord, perform multiple loops between each series of clips. These loops, in addition to their particularly unaesthetic nature, become in use dangerous to the extent that they have a tendency to hook onto the various other instruments which are in the vicinity of the cord. Moreover, they render more difficult the cleaning of the cord.

The present invention has for its object to overcome these drawbacks by providing a cord permitting avoiding loops and their unaesthetic and anti-functional character, even their dangerous character, and which is provided with a mechanism permitting ensuring the easy and rapid emplacement of a flexible conduit within this cord.

The present invention thus has for its object a supply cord for medical handpieces, particularly dental, comprising at least one recess extending longitudinally from one to the other of its ends, and at least one auxiliary longitudinal recess provided with a radial slot which extends over all its length and which places the auxiliary recess in communication with the outside, this auxiliary recess being adapted to receive a removable flexible conduit, characterized in that it is provided with a mechanism for emplacing said flexible conduit within said auxiliary recess, this mechanism comprising:

means permitting its positioning on the cord,

means permitting the positioning of the flexible conduit at the inlet of the slot of the cord,

applicator means adapted to sink the conduit into the auxiliary recess through the slot, when the mechanism is moved along the cord.

Preferably, this mechanism will comprise:

a rider provided at its base with a recess opening externally, adapted to permit its positioning on the cord, and at its upper internal portion a spacer adapted to penetrate the slot of the cord to open it,

a movable closer adapted to occupy two positions, relative to the rider, namely, an open position in which it permits the positioning of the rider on the cord, and a closed position in which it ensures the holding in position of the rider on the cord,

a movable applicator, adapted to occupy two positions relative to the rider, namely an open position in which it permits the introduction of the conduit on the rider, and a closed position, this applicator comprising at its forward internal portion means for receiving the conduit which are prolonged rearwardly by an abutment adapted to bear against the conduit to position it in the auxiliary recess through the slot, when it is in the closed position.

The supply cord according to the invention can be made of a flexible deformable material and the longitudinal auxiliary recess will have a straight cross-section slightly less than that of the removable flexible conduit so as to exert on the latter a holding force when it is in place in the auxiliary recess.

According to the invention, the radial slot can be formed during production or formed by the user himself. The present invention thus has for its object a cutting tool adapted to create in a supply cord for a medical handpiece, particularly dental, comprising at least one recess extending longitudinally from one of its ends to the other and comprising at least a longitudinal auxiliary recess adapted to receive a removable flexible conduit, a radial slot placing the auxiliary recess in communication with the exterior, characterized in that it comprises a gripping element provided at its base with a guide element with a longitudinal axis adapted to be positioned in the auxiliary recess and to move in the latter, which is surmounted by a cutting element of a height at least equal to the thickness of the wall separating the auxiliary recess from the outside.

Preferably, the cutting element will be constituted by a blade whose attack edge will be inclined relative to an axis perpendicular to the longitudinal axis of the guide element.

There will be described hereafter, by way of non-limiting example, an embodiment of the present invention, with reference to the accompanying drawings, in which:

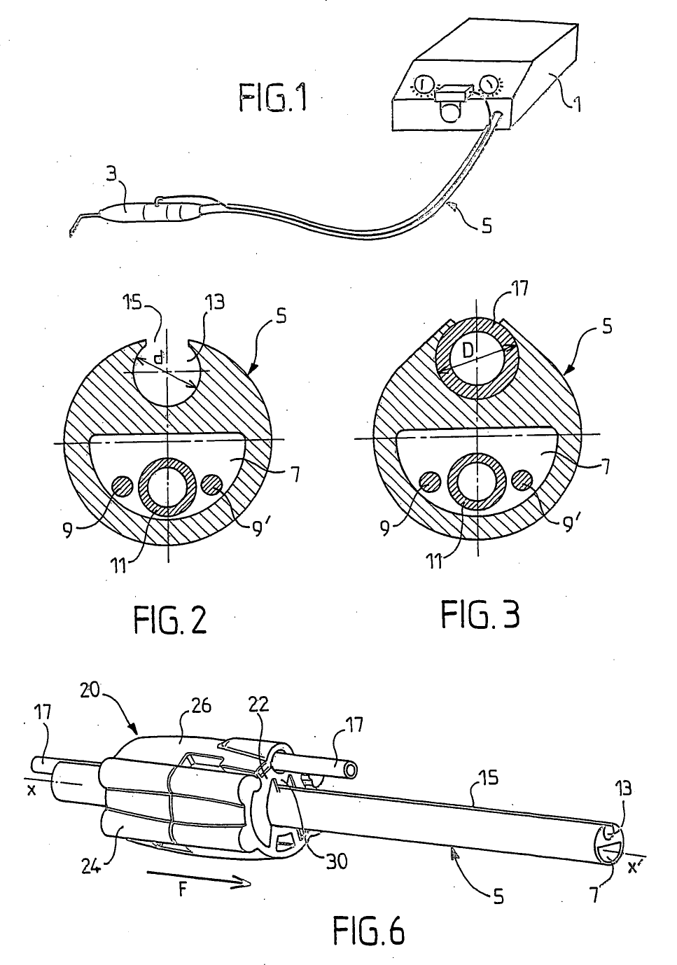

FIG. 1 is a schematic view of a dental installation using a supply cord according to the invention.

FIG. 2 is a cross-sectional view of a supply cord according to the invention, before the emplacement in the latter of an irrigation line.

FIG. 3 is a cross-sectional view of the cord according to the invention shown in FIG. 2, after the emplacement in the latter of an irrigation line.

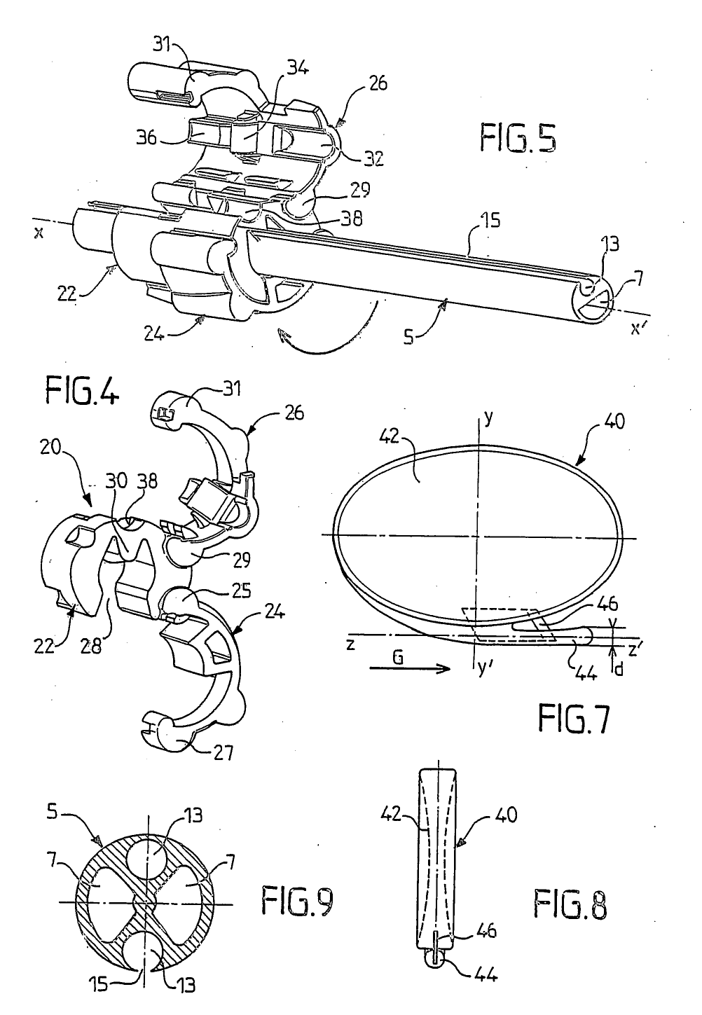

FIG. 4 is a perspective view showing the device adapted to facilitate the emplacement of a flexible irrigation conduit within an auxiliary recess of the supply cord according to the invention.

FIG. 5 is a perspective view of the device shown in FIG. 4, once the latter is positioned on the supply cord of the handpiece.

FIG. 6 is a perspective view of the device shown in FIGS. 4 and 5 in the operative position.

FIG. 7 is a plan view of a cutting tool permitting forming, in a supply cord according to the invention, a radial longitudinal slot placing the auxiliary recess in communication with the exterior.

FIG. 8 is a side view of the tool shown in FIG. 7.

FIG. 9 is a cross-sectional view of a modified embodiment of a supply cord according to the invention.

There is shown schematically in FIG. 1 an installation comprising a dental unit 1 which is connected to a handpiece 3 by a supply cord 5. This cord, whose cross-section is shown on an enlarged scale in FIGS. 2 and 3, comprises a first longitudinal recess 7 which extends from one of its ends to the other. The recess 7 receives for example two electrical sleeves 9 and 9′ which enclose a number of conductors sufficient to ensure the electrical energy supply of the handpiece 3 and its accessories. The recess 7 also receives a tube 11 ensuring the supply of water to the handpiece 3.

The cord 5 also comprises a second recess 13, or auxiliary recess, which extends also over all the length of the cord, which is substantially parallel to the first and which, in the present embodiment of the invention, is in communication with the exterior through a longitudinal and radial slot 15.

The cord 5 is made of an elastomeric material which itself confers relatively elastic characteristics permitting it to deform sufficiently so that the flexible conduit 17, particularly an irrigation line, can pass through the slot 15 and be positioned within the auxiliary recess 13.

Preferably, the diameter d of the recess 13 will be slightly less than that D of the conduit 17 such that, when the latter is in place in the recess 13, it will be held there under the force of the resilient deformation of the cord 5 and/or of the flexible conduit 17.

According to the invention, the practitioner who desires to emplace, between the handpiece 3 and the dental unit 1, an irrigation line formed of a flexible conduit 17, introduces the latter through the slot 15 into the auxiliary recess 13, as shown in FIG. 3. Although the emplacement of the flexible conduit 17 in the auxiliary recess 13 of the cord can take place in a manual manner, experience has shown that it is particularly difficult thus to produce a certain assembly such that the cord will have a certain level of flexibility. This is why use is made of a positioning mechanism holding the slot 15 open during the emplacement in the latter of the irrigation line 17.

Such a positioning mechanism 20, which is shown by way of example in FIGS. 4 to 6, is essentially constituted by three elements, namely a rider 22, a closer 24 and an applicator 26.

The rider 22 is constituted by a longitudinal element comprising at its lower portion a slot 28 adapted to receive the cord 5. The upper portion of the slot 28 comprises a protuberance 30 with a cross-section of V shape directed downwardly, which is adapted to penetrate within the slot 15 of the cord 5 when it is introduced into this latter through the slot 28 so as to spread it. Once the cord 5 is introduced into this latter, the slot 28 is closed by means of the closer 24, which for this purpose has an end 25 which is mounted movably in rotation at the base of the rider 22 and whose other end 27 is fixed by clipping on the rider 22. There is shown in FIG. 5 the cord 5 positioned in the rider 22 after rotation of the closer 24 and securement of this latter on the rider 22.

The applicator 26 is also mounted rotatably by one end 29 on the rider 22 and its other end 31 is fixed by clipping on the latter. The internal upper and forward portion of the applicator 26 is hollowed by a longitudinal cavity 32 adapted to receive the irrigation conduit 17. The cavity 32 is prolonged longitudinally toward the rear portion by an applicator abutment 34 which extends inwardly and whose thickness increases from the forward portion toward the rear portion, and which is followed by a guide element 36 constituted by a semi-cylindrical cavity matching the profile of the upper portion of the cord 5.

The upper portion of the rider 22 is hollowed by a longitudinal semi-cylindrical cavity 38 which is complementary to the semi-circular cylindrical cavity 32 provided in the applicator 26, such that, when the applicator 26 is in the closed position, or use position, as shown in FIG. 6, the conduit 17 can be placed in the two longitudinal cavities 32 and 38.

As shown in FIG. 6, when the rider 22 is in place on the cord 5 and the closer 24 is enclosed over the latter, it will be understood that the spacer 30 has the effect of opening the slot 15, such that the latter is ready to receive the conduit 17. This latter is then introduced into the cavity 38 provided in the upper portion of the rider 22 and the applicator 26 is closed over this latter. The applicator abutment 34 then applies the conduit 17 into the auxiliary longitudinal recess 13 of the cord 5 through the slot 15. If there is given to the positioning mechanism 20 a longitudinal movement along the cord 5, in the direction of the arrow F, the abutment 34 applies in the course of this movement the conduit 17 into the auxiliary recess 13. Once this latter is in place, the resilience of the cord 5 and/or that of the conduit 17 thus ensures the holding of this latter in the recess. If the user carries out this operation from one end of the cord 5 to the other end of this latter, he will carry out by the same operation the positioning of the conduit 17 in the auxiliary recess 13. Once this latter operation is over, it suffices then for the user to open the applicator 26 and the closer 24 thereby completely to disengage the positioning mechanism from the cord 5, which is provided with the conduit 17.

One could of course, according to the invention, use any other applicator device permitting ensuring the introduction of the conduit 17 into the longitudinal auxiliary recess 13 of the cord 5.

Once of the dental operation is over, to recover the sterile conduit, it suffices that the practitioner exert a force with a radial component upon one of the ends of this latter such that it frees itself from the cord 5.

It may be of interest that the cord 5 has no beginning in the slot 15, when for example it is not a matter of using a sterile conduit. It is however interesting to give to the practitioner the possibility of using the present invention by providing himself at the outset with a supply cord having a longitudinal auxiliary recess adapted to receive the flexible conduit but not comprising a radial slot. There will be described hereafter a cutting tool permitting the practitioner himself to form the radial slot placing the auxiliary recess into communication with the exterior.

Use will thus be had of a cutting tool 40 comprising a gripping portion 42 of substantially elliptical shape in this embodiment which is made, for example, of a synthetic material and which comprises at its lower portion a guide element 44 which is constituted by an elongated protuberance of substantially circular cross-section, and a diameter d′ slightly less than the diameter d of the auxiliary recess 13. The guide element 44 is connected to the gripping element 42 at the base of the tool and a recess is provided in the element 42 permitting having in this latter a cutting blade 46. Preferably, the attack surface of this cutting blade 46 is inclined relative to the axis y-y′ of the tool 40, which is itself perpendicular to the axis zz′ of the guide element 44.

Under these conditions, when a user having a supply cord 5 which is not provided at the outset with a radial slot 15, desires to provide this latter so as to introduce into the auxiliary recess 13 a flexible conduit, he introduces therein preliminarily the guide element 44 and will move with a rectangular movement the cutting tool 40 in the direction of the arrow G shown in FIG. 7, along the longitudinal axis xx′ of the cord 5. During this movement, the attack surface of the tool 46 will provide in the upper portion of the cord a radial slot 15 permitting the emplacement of a flexible conduit in the auxiliary recess 13.

Of course, there could be given to such a tool any other suitable shape permitting one or two cutting blades to make the slot 15.

The multifunction supply cord according to the invention can of course comprise several auxiliary recesses 13 adapted to receive flexible cords, in which there will be provided a slot 15 for communication with the exterior, these respective slots being adapted to be made either at the outset, or by the user himself. There is shown in FIG. 9 an example of such a cord in which the longitudinal recesses 7, of non-circular cross-section, are adapted to contain pneumatic or electric supply means for the handpiece and auxiliary recesses 13 are adapted to receive a flexible conduit. In this embodiment only the lower auxiliary recess 13 is provided with the slot 15 adapted to ensure its communication with the exterior.

1. Supply cord (5) for a medical handpiece (3), particularly dental, comprising at least one recess (7) extending longitudinally from one end to the other and at least one longitudinal auxiliary recess (13) provided with a radial slot (15) which extends over all its length and which places the auxiliary recess (13) in communication with the exterior, this auxiliary recess being adapted to receive a removable flexible conduit (17), characterized in that it is provided with a mechanism for emplacing said flexible conduit in said auxiliary recess, this mechanism comprising:
means (24) permitting its positioning on the cord (5),
means permitting the positioning of the flexible conduit (17) at the inlet of the slot (15) of the cord (5),
applicator means (34) adapted to sink the conduit (17) into the auxiliary recess (13) through the slot 15, when the mechanism is moved along the cord 5.

2. Cord according to claim 1 characterized in that said mechanism comprises:
a rider (22) provided at its base with a recess (28) open outwardly adapted to permit its positioning on the cord (5), and at its internal upper portion a spacer (30) adapted to penetrate the slot (15) of the cord (5) to open it,
a movable closer (24) adapted to occupy two positions, relative to the rider (22), namely an open position in which it permits the positioning of the rider on the cord (5), and a closed position in which it ensures the holding in position of the rider on the cord,
a movable applicator (26), adapted to occupy two positions relative to the rider (22), namely an open position in which it permits the introduction of the conduit (17) on the rider and a closed position, this applicator (26) comprising in its forward internal portion means for receiving the conduit (17) which are prolonged rearwardly by an abutment (34) adapted to bear against the conduit (17) to position it in the auxiliary recess (13) through the slot (15), when it is located in closed position.

3. Supply cord according to claim 1, characterized in that it is constituted by a flexible deformable material and that the auxiliary longitudinal recess (13) has a cross-section slightly less than that of the removable flexible conduit, so as to exert on this latter a holding force when it is in place in the auxiliary recess (13).

4. Cutting tool adapted to form in a supply cord according to claim 1 a radial slot (17) placing the auxiliary recess (13) in communication with the exterior, characterized in that it comprises a gripping element (42) provided at its base with a guide element (44) of a horizontal axis (zz′) adapted to be positioned in the auxiliary recess (13) and to move in this latter, which is surmounted by a cutting element (46) of a height at least equal to the thickness of the wall separating the auxiliary recess (13) from the exterior.

5. Tool according to claim 4 characterized in that the cutting element is constituted by a blade (46) whose attack edge is inclined relative to an axis (yy′) perpendicular to the longitudinal axis (zz′) of the guide element (44).

6. Supply cord according to claim 2, characterized in that it is constituted by a flexible deformable material and that the auxiliary longitudinal recess (13) has a cross-section slightly less than that of the removable flexible conduit, so as to exert on this latter a holding force when it is in place in the auxiliary recess (13).
